(19) United States
(12) Patent Application Publication
(10) Pub. No.: US 2026/0177972 A1
(43) Pub. Date: Jun. 25, 2026

(54) TRANSMISSION APPARATUS AND CLEANING DEVICE

(71) Applicant: Beijing Roborock Technology Co., Ltd., Beijing (CN)

(72) Inventors: Caiyun HU, Beijing (CN); Xuchang HAO, Beijing (CN); Lidong ZHAO, Beijing (CN); Jingtao JIA, Beijing (CN)

(21) Appl. No.: 19/540,095

(22) Filed: Feb. 13, 2026

Related U.S. Application Data
(63) Continuation of application No. PCT/CN2024/118560, filed on Sep. 12, 2024.

(30) Foreign Application Priority Data
Aug. 25, 2023 (CN) 202311091096.2

(51) Int. Cl. G03G 21/16; A47L 11/40; G03G 15/00

(52) U.S. Cl. CPC G03G 21/1647; A47L 11/4058; A47L 11/4066; A47L 11/4088; G03G 15/6529

(57) ABSTRACT

A transmission apparatus includes: a swing assembly, including a swing arm and a first cam, where the first cam is connected to the swing arm, and the swing arm has a first operating position and a second operating position; a drive assembly, including a second cam and a drive component, where the second cam is connected to the drive component, the second cam interacts with the first cam, and the first cam is abutted against the second cam during switching of the swing arm between the first operating position and the second operating position; and a cleaning element connected to one end of the swing arm.

### CROSS-REFERENCE TO RELATED APPLICATIONS

This application is a continuation of PCT application No. PCT/CN2024/118560, filed on Sep. 12, 2024, which claims priority to Chinese Patent Application No. 202311091096.2. filed on Aug. 25, 2023. The entire content of the foregoing applications is incorporated herein by reference as if set forth herein in its entirety.

### TECHNICAL FIELD

The present application relates to the technical field of transmission apparatuses, and in particular to a transmission apparatus and a cleaning device.

### BACKGROUND

With the iterative update and development of technology, self-cleaning devices have entered ordinary households and gradually become popular.

Among existing self-cleaning devices, there is one type having a mopping function. However, a transmission structure in an existing self-cleaning device is often simply designed and functionally limited, and can achieve cleaning only by driving a mop to rotate. To expand a cleaning range, a cleaning assembly for mopping extends beyond a projection range of a cleaning device body.

### SUMMARY

According to the first aspect of embodiments of the present application, a transmission apparatus is provided. The transmission apparatus includes:
a swing assembly, including a swing arm and a first cam, wherein the first cam is connected to the swing arm; and the swing arm has an extended first operating position and a retracted second operating position;
a drive assembly, including a second cam and a drive component, wherein the second cam is connected to the drive component;
the second cam interacts with the first cam; and the first cam is abutted against the second cam during the switching of the swing arm between the first operating position and the second operating position; and
a cleaning element connected to one end of the swing arm.

According to the second aspect of the embodiments of the present application, a cleaning device is provided. The cleaning device includes:
a device body; and
the transmission apparatus according to any one of the foregoing items, wherein the transmission apparatus is disposed in the device body;
in response to the swing arm moving to the first operating position, the cleaning element extends beyond a projection of the device body on the floor; and
in response to the swing arm moving to the second operating position, the cleaning element at least partially enters the projection of the device body on the floor.

### BRIEF DESCRIPTION OF DRAWINGS

Various other advantages and benefits will become apparent to those of ordinary skill in the art upon reading the following detailed description of preferred embodiments. The accompanying drawings are merely intended to illustrate the preferred implementations and are not intended to limit the present application. In addition, in all the accompanying drawings, the same reference numeral is used to denote the same component. In the accompanying drawings:

FIG. 1 is a structural block diagram of a transmission apparatus whose swing arm is at a second operating position according to an embodiment of the present application;

FIG. 2 is a schematic structural diagram of a transmission apparatus whose swing arm moves from a second operating position to a first operating position according to an embodiment of the present application;

FIG. 3 is a schematic structural diagram of a transmission apparatus whose swing arm moves from a second operating position to a first operating position according to an embodiment of the present application;

FIG. 4 is a schematic structural diagram of a transmission apparatus whose swing arm is at a first operating position according to an embodiment of the present application;

FIG. 5 is a schematic structural diagram of a transmission apparatus having a second anti-wear structure according to an embodiment of the present application;

FIG. 6 is a schematic structural diagram of a transmission apparatus having a buffer member according to an embodiment of the present application from another angle;

FIG. 7 is a schematic structural diagram of a transmission apparatus having a buffer member according to an embodiment of the present application;

FIG. 8 is a schematic structural diagram of a cleaning device whose swing arm is at a second operating position according to an embodiment of the present application; and

FIG. 9 is a schematic structural diagram of a cleaning device whose swing arm is at a first operating position according to an embodiment of the present application.

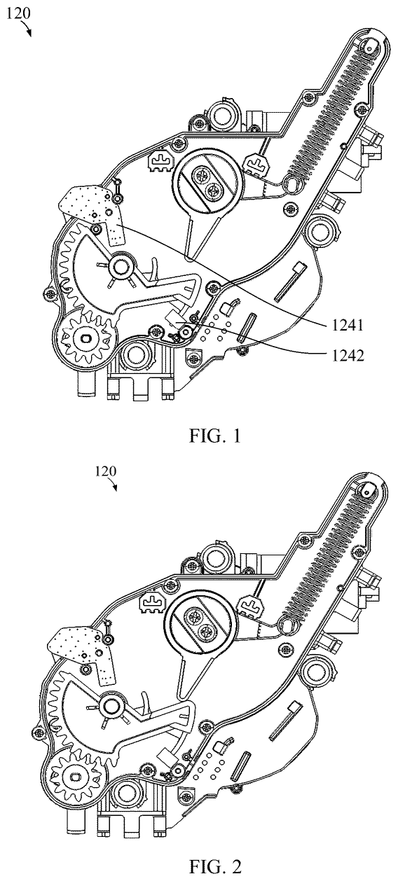

Correspondences between reference numerals and component names in FIG. 1 to FIG. 9 are as follows:
100: cleaning device;
110: device body; 120: transmission apparatus;
121: swing assembly; 122: drive assembly; 123: cleaning element; 124: position detecting apparatus; 125: first limiting member; 126: second limiting member; 127: anti-wear structure; 128: buffer member; 129: housing;
1212: elastic member; 1213: first cam;
1221: second cam; 1222: drive component;
1241: first photoelectric switch; 1242: second photoelectric switch;
1271: first anti-wear structure; 1272: second anti-wear structure;
12211: sector-shaped gear portion; 12212: abutting portion; 12213: first baffle; 12214: second baffle; 12215: circular arc surface;
12221: drive motor; and 12222: drive gear.

### DETAILED DESCRIPTION

In order to better understand the above-mentioned technical solutions, the technical solutions of the embodiments of the present application are described in detail below with reference to the accompanying drawings and the specific embodiments, and it should be understood that the embodiments of the present application and the specific features in the embodiments are of a detailed description of the technical solutions of the embodiments of the present application, and are not the limitations on the technical solutions of the present application. Without conflict, the embodiments of the present disclosure and the technical features in the embodiments may be combined with each other.

Among existing self-cleaning devices, there is one type having a mopping function. However, a transmission structure in an existing self-cleaning device is often simply designed and functionally limited, and can achieve cleaning only by driving a mop to rotate. To expand a cleaning range, a cleaning assembly for mopping extends beyond a projection range of a cleaning device body. This hinders the advancement of the cleaning device when it encounters obstacles. Moreover, because the extended cleaning portion is often structurally vulnerable, frequent collisions may even shorten the service life of the cleaning device.

The present disclosure aims to resolve at least one of technical problems existing in the prior art or related technology.

As shown in FIG. 1 to FIG. 6, according to a first aspect of embodiments of the present application, a transmission apparatus 120 is provided. The transmission apparatus includes: a swing assembly 121, a drive assembly 122, and a cleaning element 123, wherein the swing assembly 121 includes a swing arm and a first cam 1213; the first cam 1213 is connected to the swing arm; the swing arm has an extended first operating position and a retracted second operating position; the drive assembly 122 includes a second cam 1221 and a drive component 1222; the second cam 1221 is connected to the drive component 1222; the second cam 1221 interacts with the first cam 1213; the first cam 1213 is abutted against the second cam 1221 during the switching of the swing arm between the first operating position and the second operating position; and the cleaning element 123 is connected to one end of the swing arm.

The cleaning element 123 may generally be a flexible water-absorbing material such as fabric or sponge. In this solution, the cleaning element 123 may be a self-rotating cleaning element 123, or a vibrating cleaning element 123, or a fixed cleaning element 123. Specifically, the cleaning element 123 may be a mop tray; and the cleaning element 123 removes stains from a floor via rotational motion.

The swing assembly 121 is in contact with the drive assembly 122 during the switching of the swing arm between the first operating position and the second operating position, thereby driving the cleaning element 123 to move.

Specifically, the extended state of the first operating position is defined as follows: the swing arm drives the cleaning element 123 to extend out of a projection area of the device body 110 or away from the device body 110. Specifically, the retracted state of the second operating position is defined as follows: the swing arm drives the cleaning element 123 to approach the device body 110 or retract into the projection area of the device body 110.

FIG. 1 shows a schematic structural diagram of a transmission apparatus 120 whose swing arm is at a first operating position. FIG. 1 to FIG. 4 shows schematic structural diagrams of a transmission apparatus 120 whose swing arm is switched from a first operating position to a second operating position. Therefore, the transmission apparatus 120 can be applied to the field of household cleaning. In response to the cleaning device 100 encountering an obstacle during traveling, the drive component 1222 drives the second cam 1221 to rotate; as the second cam 1221 is abutted against the first cam 1213, the first cam 1213 is driven to rotate; and as the first cam 1213 is connected to the swing arm, the swing arm is driven to rotate, such that the swing arm is switched from the extended first operating position to the retracted second operating position. According to the present disclosure, complex functions are implemented via a simple structure, that is, due to the arrangement of the first cam 1213 and the second cam 1221, the cleaning device 100 employing the transmission apparatus 120 can, upon encountering an obstacle when traveling along a wall or when the cleaning element is extended, retract the cleaning element 123. This not only improves the flexibility of the cleaning device 100, but also reduces the collision of the cleaning element 123 and the swing arm, prolongs the service life of the cleaning device 100, and enhances users'cleaning experience.

As shown in FIG. 1, in a case where the swing arm is at the first operating position, the second cam 1221 is separated from the first cam 1213.

This arrangement can ensure that when the cleaning element 123 collides with an obstacle, the resulting force is only transmitted to the first cam 1213, not to the drive component 1222 through the second cam 1221, such that a force exerted on the drive component 1222 is reduced, thereby protecting the drive component 1222. Meanwhile, part tolerance is absorbed to prevent the swing arm from failing to fully extend to the first operating position.

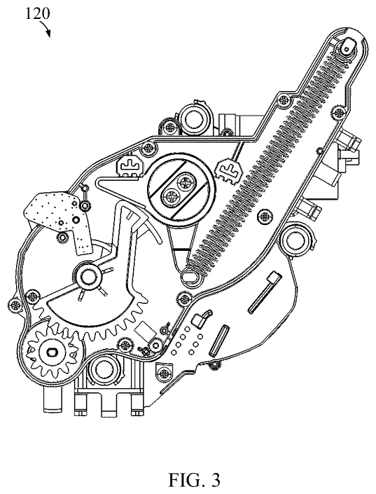

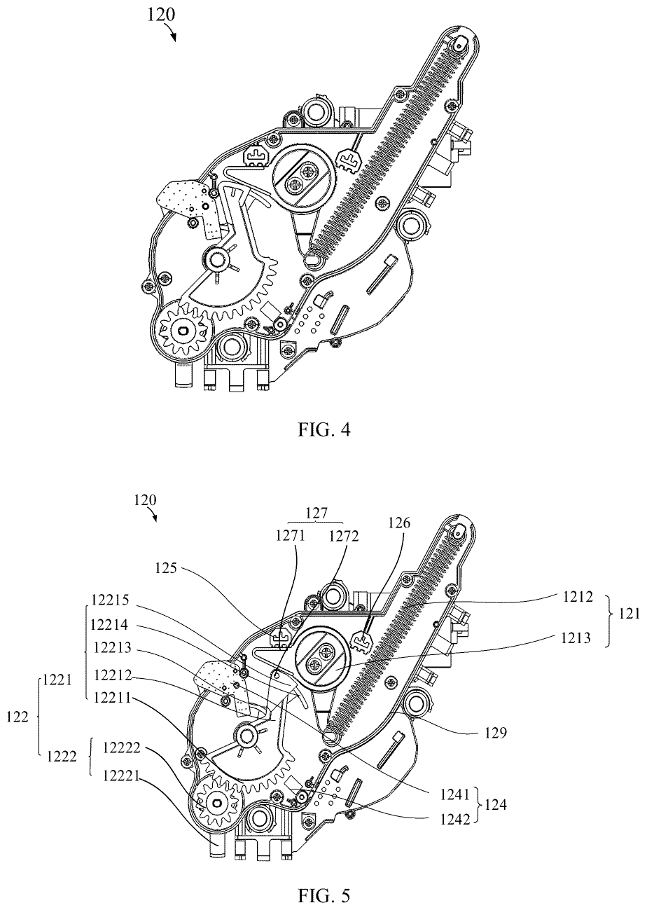

As shown in FIG. 3 and FIG. 4, the second cam 1221 has a limit position; during the switching of the swing arm from the first operating position to the second operating position, the second cam 1221 rotates towards the limit position; and in response to the swing arm reaching the second operating position, the second cam 1221 has not reached the limit position and continues rotating towards the limit position until the second cam 1221 reaches the limit position.

In response to the swing arm reaching the second operating position, the second cam 1221 continues rotating until the second cam 1221 reaches the limit position. The additional travel path of the second cam 1221 can absorb part tolerance, which in turn ensures that the swing arm can be switched to the second operating position, and prevents the cleaning element 123 from failing to retract fully.

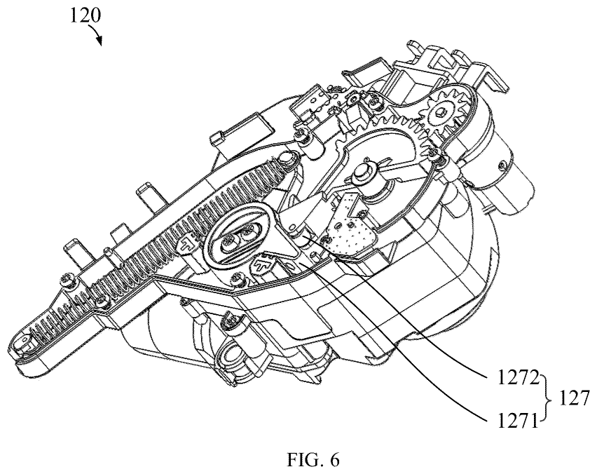

As shown in FIG. 5 and FIG. 6, the transmission apparatus 120 further includes: an anti-wear structure 127 disposed on the first cam 1213 and/or disposed on the second cam 1221.

The anti-wear structure 127 includes:
a first anti-wear structure 1271, wherein the first anti-wear structure 1271 is a metal protective layer, and is disposed on the first cam 1213, that is, disposed on a surface of the first cam 1213 in contact with the second cam 1221.

The anti-wear structure 127 further includes: a second anti-wear structure 1272, wherein the second anti-wear structure 1272 is a roller structure, and is disposed on the second cam 1221, that is, disposed on an end surface of the second cam 1221 in contact with the first cam 1213.

In this technical solution, the first anti-wear structure 1271 is provided on the surface of the first cam 1213 in contact with the second cam 1221, and the first anti-wear structure 1271 is a metal steel sheet, or is made of another wear-resistant material, including but not limited to polyether ketone (PK) and powder metallurgy material, such that wear between the two cams can be reduced. The second anti-wear structure 1272 is a roller structure, and is disposed on the end surface of the second cam 1221 in contact with the first cam 1213. Specifically, the quantity of second anti-wear structures 1272 is not fixed, only one second anti-wear structure 1272 may be disposed on the end surface of the second cam 1221 that comes into contact with the first cam 1213 first, or second anti-wear structures 1272 may be disposed on the entire surface of the second cam 1221 in contact with the first cam 1213. This arrangement changes sliding friction to rolling friction, which reduces a frictional force.

Due to the arrangement of the first anti-wear structure 1271 and the second anti-wear structure 1272, wear between the first cam 1213 and the second cam 1221 during the operation of the transmission apparatus 120 can be reduced, such that the service life of the apparatus can be effectively prolonged.

Specifically, the second cam 1221 may be directly disposed at an output end of the drive component 1222, such that the drive component 1222 directly drives the second cam 1221 to rotate; or the output end of the drive component 1222 may be in transmission connection with the second cam 1221, and thus the drive component 1222 may likewise drive the second cam 1221 to rotate.

As shown in FIG. 1 to FIG. 4, the second cam 1221 includes: a sector-shaped gear portion 12211 and an abutting portion 12212, wherein the drive assembly 122 is meshed with the sector-shaped gear portion 12211; and the abutting portion 12212 is abutted against the swing assembly 121.

The sector-shaped gear portion 12211 and the abutting portion 12212 are distributed circumferentially spaced apart around a rotating shaft of the second cam 1221, such that the second cam 1221 may drive both the sector-shaped gear portion 12211 and the abutting portion 12212 to rotate at the same time when rotating.

As shown in FIG. 1 to FIG. 6, the second cam 1221 further includes:
a circular arc surface 12215 provided on the abutting portion 12212, wherein in response to the swing arm switching to the second operating position, the circular arc surface 12215 is tangent to the first cam 1213.

In this embodiment, in response to the swing arm reaching the second operating position, the first cam 1213 and the second cam 1221 enter a tangent state. At this time, the second cam 1221 has not reached the limit position. Therefore, the second cam 1221 continues rotating. In this process, the second cam 1221 and the first cam 1213 are in the tangent state all the time. This arrangement can ensure that the second cam 1221 does not further squeeze the first cam 1213 while absorbing part tolerance. In addition, the reaction force of the first cam 1213 is transmitted to the second cam 1221 through a tangent surface, and mostly absorbed by the rotating shaft of the second cam 1221, such that this force does not act on the drive component 1222, thereby further prolonging the service life of the drive component 1222.

A direction of a force exerted at a tangent point between the circular arc surface 12215 and the first cam 1213 passes through the rotating shaft of the second cam 1221.

In the case where the second cam 1221 is tangent to the first cam 1213 and the direction of the force exerted passes through the rotating shaft of the second cam 1221, the rotating shaft of the second cam 1221 does not receive any torque, and can absorb all the reaction force of the first cam 1213, thereby further reducing the force exerted on the drive component 1222.

The drive component 1222 includes: a drive motor 12221; and a drive gear 12222. The drive gear 12222 is disposed at an output end of the drive motor 12221; and the drive gear 12222 is meshed with the sector-shaped gear portion 12211, such that the drive motor 12221 drives, through the drive gear 12222, the second cam 1221 to rotate, thereby driving the swing arm of the swing assembly 121 to rotate from the first operating position to the second operating position.

Therefore, as shown in FIG. 1 to FIG. 4, the drive motor 12221 rotates in one direction such as clockwise or counterclockwise to drive the drive gear 12222 to rotate. Because the sector-shaped gear portion 12211 is meshed with the drive gear 12222, the second cam 1221 can be driven to rotate by the sector-shaped gear portion 12211, thereby driving the abutting portion 12212 to rotate. Because the abutting portion 12212 is abutted against the first cam 1213 in this embodiment, the first cam 1213 can be driven to rotate. Because the first cam 1213 is coaxially disposed with the swing arm, the swing arm can rotate synchronously with the first cam 1213, thereby driving the swing arm and the cleaning element 123 mounted on the swing arm to move.

As shown in FIG. 1 to FIG. 4, the swing assembly 121 further includes an elastic member 1212. The elastic member 1212 is connected to the swing arm; and the swing arm switches from the second operating position to the first operating position under the action of the elastic member 1212.

As shown in FIG. 1 to FIG. 4, the drive assembly 122 drives, through the swing arm, the cleaning element 123 to move to the second operating position. At this time, the direction of an acting force exerted by the drive assembly 122 on the swing arm is opposite to that of an acting force exerted by the elastic member 1212 on the swing arm. Therefore, the swing arm is locked via the two opposite acting forces, which in turn prevents the swing arm from swinging, thereby preventing the cleaning element 123 from moving with the swing arm during sweeping.

In response to the swing arm being at the first operating position, the elastic member 1212 is also in an extended state; and the swing arm is locked via a deformation restoring force, thereby preventing frequent swinging of the swing arm during traveling.

Specifically, the elastic member 1212 may be a tension spring, a torsion spring, an elastic sheet, or the like. In this embodiment, a tension spring is used as the elastic member 1212.

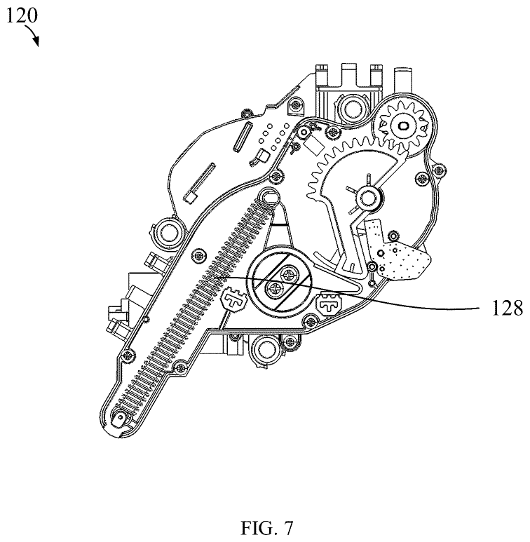

As shown in FIG. 7, the transmission apparatus 120 further includes: a buffer member 128 disposed on the elastic member 1212 and/or disposed on a rotating shaft of the first cam 1213.

The buffer member 128 includes a first buffer member and a second buffer member. The first buffer member is a rotating shaft damper, is disposed on the rotating shaft of the first cam 1213, and reduces a rotational speed of the first cam 1213 during the switching of the swing arm between the first operating position and the second operating position.

The second buffer member is disposed in the elastic member 1212, and the second buffer member reduces a rebound speed of the elastic member 1212 during the switching of the swing arm between the first operating position and the second operating position.

Due to the arrangement of the first buffer member and the second buffer member, the following phenomena can be reduced: during release of elastic potential energy by the elastic member 1212, the first cam 1213 rotates faster, and an impact force generated thereby shortens the service life of the element. Moreover, potential safety hazards, such as hand pinching and impacts, caused by excessively rapid swinging of the swing arm are avoided.

Specifically, the swing arm is provided with shock-absorbing soft rubber.

Therefore, potential safety hazards, such as hand pinching and impacts, caused by the swing arm rebounding can be further avoided.

As shown in FIG. 1 to FIG. 4, the elastic member 1212 is connected to the first cam 1213; and/or the elastic member 1212 is connected to the swing arm.

In this embodiment, by taking the elastic member 1212 being a tension spring as an example, one end of the elastic member 1212 may be indirectly or directly secured to the housing 129, that is, be stationary relative to the housing 129; and the other end of the elastic member may be separately connected to the first cam 1213, or may be connected to the swing arm, or may be connected to both the first cam 1213 and the swing arm. For example, the elastic member 1212 has a Y-shaped structure, and thus can be connected to both the first cam 1213 and the swing arm. Certainly, the elastic member may also be connected to both the first cam 1213 and the swing arm via a connecting component, for example, a connecting line.

As shown in FIG. 1 to FIG. 4, in this embodiment, the elastic member 1212 is connected to the first cam 1213; a connecting portion is disposed on a circumferential side of the first cam 1213; and the connecting portion is configured to be connected to the elastic member 1212.

The connecting portion may protrude outwards in a radial direction of the first cam 1213. The elastic member 1212 is connected to an end of the connecting portion to acquire greater torque.

The connecting portion may be integrally formed with the remaining parts of the cam during manufacture.

As shown in FIG. 1 to FIG. 4, in response to the first cam 1213 rotating in the first direction under the drive of the drive assembly 122, the swing arm switches from the first operating position to the second operating position.

In this technical solution, the drive assembly 122 is configured to drive the first cam 1213 to rotate in the first direction, such that the cleaning element 123 is switched from the first operating position to the second operating position. The elastic member 1212 is configured to drive the first cam 1213 to rotate in the second direction, such that the cleaning element 123 is switched from the second operating position to the first operating position.

The first direction and the second direction are two opposite directions.

As shown in FIG. 1 to FIG. 4, in response to the swing arm switching from the first operating position to the second operating position, the drive assembly 122 drives, through the first cam 1213, the elastic member 1212 to deform, thereby accumulating elastic potential energy. In response to the elastic member 1212 releasing the elastic potential energy, the swing arm can be driven to switch from the second operating position to the first operating position.

Specifically, the transmission apparatus 120 further includes a housing 129. One end of the elastic member 1212 is fixed relative to the housing 129; and the swing arm is disposed outside the housing 129.

In this embodiment, the drive gear 12222, the second cam 1221, the first cam 1213, and the elastic member 1212 are all disposed in the housing 129. Accordingly, the housing 129 plays a good protective role, which is beneficial to not only prolonging the service life and enhancing the reliability, but also ensuring good transmission precision.

Specifically, the housing 129 may include a first upper housing and a first lower housing that are detachably connected to each other. Therefore, disassembly and assembly of the housing 129 are facilitated; and disassembly and assembly of the drive gear 12222, the second cam 1221, the first cam 1213, and the elastic member 1212 are also facilitated, thereby facilitating disassembly and assembly of the drive assembly 122. Specifically, the first upper housing and the first lower housing may be detachably connected via at least one of a screw, a snap-fit structure, a mortise and tenon structure, and/or a magnetic attraction structure.

As shown in FIG. 1 to FIG. 4, the transmission apparatus further includes: a position detecting apparatus 124 configured to detect a rotational position of the second cam 1221. The drive component 1222 rotates or stops rotating according to a detection result of the position detecting apparatus 124.

Due to the arrangement of the position detecting apparatus 124, the rotational position of the second cam 1221 can be detected, and thus a rotational position of the first cam 1213 in this embodiment can be further known. Therefore, in response to the first cam 1213 rotating to an appropriate position, for example, rotation of the first cam 1213 driving the swing arm to move to the first operating position or the second operating position, the drive motor 12221 stops rotating according to a current detection result of the position detecting apparatus 124, such that the swing arm can be maintained at the first operating position or the second operating position to implement accurate switching between the first operating position and the second operating position. It may be understood that in response to the first cam 1213 rotating, and the swing arm having not moved to the first operating position or the second operating position, the drive motor 12221 may continue rotating according to the current detection result of the position detecting apparatus 124, thereby driving the swing arm to continue moving towards a target operating position, for example, the first operating position or the second operating position.

The position detecting apparatus 124 may include a photoelectric switch, a mechanical switch, or another detection mechanism that meets the requirements, or the like.

As shown in FIG. 1 to FIG. 4, the position detecting apparatus 124 includes: a first photoelectric switch 1241; and a second photoelectric switch 1242. The first photoelectric switch 1241 and the second photoelectric switch 1242 are disposed on two sides of the second cam 1221, respectively. The second cam 1221 further includes: a first baffle 12213; and a second baffle 12214. The first baffle 12213 and the second baffle 12214 are disposed on two sides of the abutting portion 12212, respectively; the first baffle 12213 is configured to be inserted into the first photoelectric switch 1241, such that the first photoelectric switch 1241 changes a detection signal; and the second baffle 12214 is configured to be inserted into the second photoelectric switch 1242, such that the second photoelectric switch 1242 changes a detection signal.

In this embodiment, as the first photoelectric switch 1241 and the second photoelectric switch 1242 are disposed on the two sides of the second cam 1221, respectively to detect whether the swing arm has reached the first operating position and the second operating position, respectively, the accuracy of detecting whether the swing arm has reached the target operating position can be improved.

The photoelectric switch generally includes a light emitting portion and a light receiving portion. The detection signal of the photoelectric switch changes based on whether the light receiving portion can receive an optical signal from the light emitting portion. By providing the first baffle 12213 and the second baffle 12214 on the second cam 1221, rotation of the second cam 1221 can drive the first baffle 12213 and the second baffle 12214 to rotate synchronously. The first baffle 12213 and the second baffle 12214 are distributed on two sides of the abutting portion 12212 respectively. In response to the second cam 1221 rotating to an appropriate position, the first baffle 12213 is inserted into the first photoelectric switch 1241, such that the first photoelectric switch 1241 changes the detection signal. For example, the first baffle 12213 is disposed between the light emitting portion and the light receiving portion of the first photoelectric switch 1241 to prevent the light receiving portion from receiving the optical signal emitted by the light emitting portion, such that the first photoelectric switch 1241 changes the detection signal. This indicates that in response to the first cam 1213 rotating to the appropriate position, the swing arm is at the first operating position. In this case, the drive motor may stop rotating according to the detection signal of the first photoelectric switch 1241, such that the swing arm is maintained at the first operating position.

In response to the second cam 1221 rotating to an appropriate position, the second baffle 12214 is inserted into the second photoelectric switch 1242, such that the second photoelectric switch 1242 changes the detection signal. For example, the second baffle 12214 is disposed between the light emitting portion and the light receiving portion of the second photoelectric switch 1242 to prevent the light receiving portion from receiving the optical signal emitted by the light emitting portion, such that the second photoelectric switch 1242 changes the detection signal. This indicates that in response to the first cam 1213 rotating to the appropriate position, the swing arm is at the second operating position. In this case, the drive motor 12221 may stop rotating according to the detection signal of the second photoelectric switch 1242, such that the swing arm is maintained at the second operating position.

In some possible embodiments, the transmission apparatus further includes: a rotation angle detecting apparatus disposed on the drive motor 12221 and configured to detect a rotation angle of an output shaft of the drive motor 12221. The drive motor 12221 also rotates or stops rotating according to a detection result of the rotation angle detecting apparatus.

Due to the arrangement of the rotation angle detecting apparatus, the rotation angle of the output shaft of the drive motor 12221 can be detected. Therefore, a rotation angle of the drive gear 12222 and a rotation angle of the second cam 1221 can be known. Furthermore, a rotation angle of the first cam 1213 can be known. Therefore, in response to the first cam 1213 rotating to an appropriate angle, for example, rotation of the first cam 1213 driving the swing arm to move to the first operating position or the second operating position, the drive motor 12221 stops rotating according to a current detection result of the rotation angle detecting apparatus, such that the swing arm can be maintained at the first operating position or the second operating position to implement accurate switching between the first operating position and the second operating position. It may be understood that in response to the first cam 1213 rotating and the swing arm being driven but having not moved to the first operating position or the second operating position, the drive motor 12221 may continue rotating according to the current detection result of the rotation angle detecting apparatus, thereby driving the swing arm to continue moving towards a target operating position, for example, the first operating position or the second operating position.

As shown in FIG. 1 to FIG. 4, in some possible embodiments of the present disclosure, a first limiting member 125 and a second limiting member 126 are disposed on a circumferential side of the first cam 1213; in response to the swing arm moving towards the first operating position, a protrusion of the first cam 1213 approaches the first limiting member 125; in response to the swing arm moving towards the second operating position, the protrusion of the first cam 1213 approaches the second limiting member 126; and the first limiting member 125 and the second limiting member 126 are configured to abut against the protrusion of the first cam 1213 to limit rotation of the first cam 1213.

In this way, rotation of the first cam 1213 can be limited. For example, after the first cam 1213 rotates to an appropriate position, the protrusion of the first cam 1213 is abutted against the first limiting member 125, such that the first cam 1213 does not continue moving towards the first limiting member 125. Therefore, the swing arm can be reliably and accurately maintained at the first operating position. In addition, after the first cam 1213 rotates to an appropriate position, the protrusion of the first cam 1213 is abutted against the second limiting member 126, such that the first cam 1213 does not continue moving towards the second limiting member 126. Therefore, the swing arm can be reliably and accurately maintained at the second operating position.

It may be understood that in this state, even if the drive assembly 122 continues driving, the first cam 1213 does not continue rotating under the action of the first limiting member 125 or the second limiting member 126. Therefore, even if the position detecting apparatus 124 and the rotation angle detecting apparatus become faulty, the swing arm can be reliably maintained at the first operating position or the second operating position, which achieves double confirmation, thereby improving the accuracy and reliability of the cleaning element 123 reaching the target operating position.

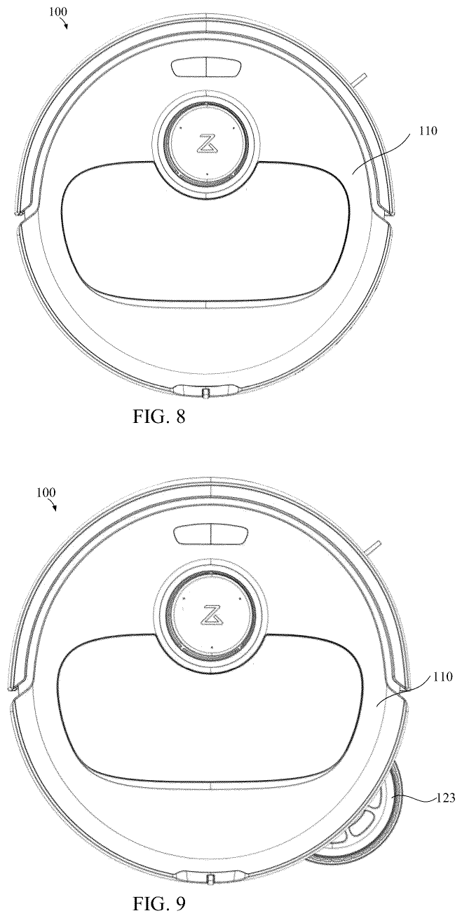

As shown in FIG. 8 and FIG. 9, according to a second aspect of the embodiments of the present application, a cleaning device 100 is provided. The cleaning device includes a device body 110, and the transmission apparatus 120 according to any one of the foregoing items. The transmission apparatus 120 is disposed in the device body 110; and in response to the swing arm moving to the first operating position, the cleaning element 123 extends beyond a projection of the device body 110 on the floor.

When the swing arm is at the first operating position and the second operating position, projections of the cleaning element 123 are at different positions in a projection region of the device body 110.

As shown in FIG. 8 and FIG. 9, when the swing arm is at the second operating position, the projection of the cleaning element 123 is at least partially within the projection region of the device body 110. As shown in FIG. 8 and FIG. 9, when the swing arm is at the first operating position, the projection of the cleaning element 123 is at least partially outside the projection region of the device body 110. It may be understood that when the swing arm is at the first operating position and the second operating position, the cleaning element 123 can be at least partially within the projection region of the device body 110 but at different positions. The essential difference is: the area of the cleaning element 123 extending beyond the projection region of the device body 110 when the swing arm is at the first operating position is greater than the area of the cleaning element 123 extending beyond the projection region of the device body when the swing arm is at the second operating position.

When the swing arm is at the second operating position, the cleaning element 123 is at least partially outside an edge projection region of the device body 110, such that the cleaning range of the cleaning element 123 can exceed an edge of a traveling range of the device body 110. Therefore, a corner position to which the device body 110 cannot be fitted can be cleaned completely, thereby enlarging the cleaning range of the cleaning element 123 and improving the cleaning effect of the cleaning device 100.

When the swing arm is at the second operating position, the cleaning element 123 may be completely outside the edge projection region of the device body 110, or may be partially outside the edge projection region of the device body 110, which may be specified based on a specific structure.

When the swing arm is at the first operating position, the cleaning element 123 may be within the edge projection region of the device body 110, such that the cleaning range of the cleaning element 123 can be within the traveling range of the device body 110. Therefore, a mopping operation can be performed in a region within the traveling range of the device body 110; and the possibility that the cleaning element 123 protrudes from the device body 110 and thus collides with an obstacle can be reduced, which is beneficial to prolonging the service life and enhancing the reliability of the cleaning element 123.

Further, the swing arm may be selectively driven to switch between the first operating position and the second operating position based on whether the cleaning device 100 is required to perform corner mopping. For example, the swing arm is switched to the first operating position, such that the cleaning element 123 performs a conventional wet cleaning operation and can perform a wet cleaning operation on a corner; or the swing arm is moved to the second operating position, such that the cleaning element 123 can avoid an obstacle when encountering the obstacle, thereby meeting different functional requirements and improving the intelligence of the cleaning device 100.

In the present disclosure, the terms “first”, “second” and “third” are only used for descriptive purposes and cannot be understood as indicating or implying relative importance. Unless otherwise clearly defined, the term “a plurality of” refers to two or more. The terms “mount”, “connect”, “connection”, “secure” and the like should be interpreted in a broad sense. For example, the term “connection” may refer to a fixed connection, a detachable connection or an integrated connection; and the term “connected” may refer to directly connected or indirectly connected via an intermediate medium. For those of ordinary skill in the art, specific meanings of the foregoing terms in the present disclosure may be understood based on specific situations.

In the descriptions of the present disclosure, it should be understood that orientation or positional relationships indicated by the terms “upper”, “lower”, “left”, “right”, “front”, “rear”, and the like are orientation or positional relationships shown on the basis of the drawings, and are only for ease of describing the present disclosure and simplifying its descriptions, but not for indicating or implying that the specified apparatus or unit must have a specific direction or must be constructed or operated in a specific orientation, and therefore, should not be understood as limitations on the present disclosure.

In the description, the description of the terms “an embodiment”, “some embodiments”, “specific embodiments” and the like means that specific features, structures, materials or characteristics described in conjunction with the embodiment(s) or example(s) are included in at least one embodiment or example of the present disclosure. In the present description, the illustrative expressions of the above terms do not necessarily refer to the same embodiments or examples. Moreover, the specific features, structures, materials or characteristics described may be combined in any one or more embodiments or examples in any suitable manner.

Described above are only preferred embodiments of the present disclosure, but are not intended to limit the present disclosure. Various changes and modifications may be made to the present disclosure for those skilled in the art. Any modifications, equivalent substitutions, improvements, etc. made within the spirit and principles of the present disclosure are included within the protection scope of the present disclosure.

What is claimed is:

1. A transmission apparatus, comprising:
a swing assembly, comprising a swing arm and a first cam, wherein the first cam is connected to the swing arm; and the swing arm has a first operating position and a second operating position;
a drive assembly, comprising a second cam and a drive component, wherein the second cam is connected to the drive component,
wherein the second cam interacts with the first cam; and the first cam is abutted against the second cam during switching of the swing arm between the first operating position and the second operating position; and
a cleaning element connected to one end of the swing arm.

2. The transmission apparatus according to claim 1, wherein
in response to the swing arm being at the first operating position, the second cam is separated from the first cam.

3. The transmission apparatus according to claim 1, wherein
the second cam has a limit position; during switching of the swing arm from the first operating position to the second operating position, the second cam rotates towards the limit position; and in response to the swing arm reaching the second operating position, the second cam has not reached the limit position and continues rotating towards the limit position until the second cam reaches the limit position.

4. The transmission apparatus according to claim 1, further comprising at least one of:
a first anti-wear structure disposed on the first cam, or
a second anti-wear structure disposed on the second cam.

5. The transmission apparatus according to claim 4, wherein the first anti-wear structure is a metal protective layer, and is disposed on a surface of the first cam in contact with the second cam.

6. The transmission apparatus according to claim 4, wherein the second anti-wear structure is a roller structure, and is disposed on an end surface of the second cam in contact with the first cam.

7. The transmission apparatus according to claim 1, wherein
the second cam is disposed at an output end of the drive component, such that the drive component drives the second cam to rotate;
or
the output end of the drive component is in transmission connection with the second cam.

8. The transmission apparatus according to claim 1, wherein
the second cam comprises an abutting portion, wherein the abutting portion is abutted against the swing assembly; and
the second cam is in transmission connection with the drive component, and further comprises a sector-shaped gear portion; and the drive assembly is meshed with the sector-shaped gear portion.

9. The transmission apparatus according to claim 8, wherein the second cam further comprises:
a circular arc surface provided on the abutting portion, wherein in response to the swing arm switching to the second operating position, the circular arc surface is tangent to the first cam.

10. The transmission apparatus according to claim 9, wherein
a direction of a force exerted at a tangent point between the circular arc surface and the first cam passes through a rotating shaft of the second cam.

11. The transmission apparatus according to claim 8, wherein the drive component comprises:
a drive motor; and
a drive gear disposed at an output end of the drive motor, wherein the drive gear is meshed with the sector-shaped gear portion, such that the drive motor drives, through the drive gear, the second cam to rotate, thereby driving the swing arm of the swing assembly to rotate from the first operating position to the second operating position.

12. The transmission apparatus according to claim 1, further comprising:
an elastic member acting on the swing arm, wherein the swing arm switches from the second operating position to the first operating position under action of the elastic member.

13. The transmission apparatus according to claim 12, further comprising at least one of:
a first buffer member disposed on a rotating shaft of the first cam; or
a second buffer member disposed on the elastic member.

14. The transmission apparatus according to claim 13, wherein the first buffer member is a rotating shaft damper, is disposed on the rotating shaft of the first cam, and is configured to reduce a rotational speed of the first cam during the switching of the swing arm between the first operating position and the second operating position.

15. The transmission apparatus according to claim 13, wherein the buffer member comprises:
a second buffer member, wherein the second buffer member is disposed in the elastic member, and the second buffer member is configured to reduce a rebound speed of the elastic member during the switching of the swing arm between the first operating position and the second operating position.

16. The transmission apparatus according to claim 12, wherein
the elastic member is connected to the first cam; or
the elastic member is connected to the swing arm; or
the elastic member is connected to the first cam; a connecting portion is disposed on a circumferential side of the first cam; and the connecting portion is configured to be connected to the elastic member.

17. The transmission apparatus according to claim 12, wherein
the first cam rotates in a first direction or a second direction; and in response to the first cam rotating in the first direction under the drive of the drive assembly, the swing arm switches from the first operating position to the second operating position; or
in response to the swing arm switching from the first operating position to the second operating position, the elastic member stores energy; or
in response to the elastic member releasing stored energy, the swing arm switches from the second operating position to the first operating position.

18. The transmission apparatus according to claim 8, further comprising:
a position detecting apparatus configured to detect a rotational position of the second cam, wherein the drive component rotates or stops rotating according to a detection result of the position detecting apparatus.

19. The transmission apparatus according to claim 1, wherein
a first limiting member and a second limiting member are disposed on a circumferential side of the first cam; the first cam comprises a protrusion; in response to the swing arm moving towards the first operating position, the protrusion of the first cam approaches the first limiting member; in response to the swing arm moving towards the second operating position, the protrusion of the first cam approaches the second limiting member; and the first limiting member and the second limiting member are configured to abut against the protrusion of the first cam to limit rotation of the first cam; or
the first cam is coaxially disposed with the swing arm.

20. A cleaning device, comprising:
a device body; and
a transmission apparatus, wherein the transmission apparatus is disposed in the device body, and comprises:
a swing assembly, comprising a swing arm and a first cam, wherein the first cam is connected to the swing arm; and the swing arm has a first operating position and a second operating position;
a drive assembly, comprising a second cam and a drive component, wherein the second cam is connected to the drive component, wherein the second cam interacts with the first cam; and the first cam is abutted against the second cam during switching of the swing arm between the first operating position and the second operating position; and
a cleaning element connected to one end of the swing arm, wherein
in response to the swing arm moving to the first operating position, the cleaning element extends beyond a projection of the device body on the floor; and
in response to the swing arm moving to the second operating position, the cleaning element at least partially enters the projection of the device body on the floor.
